(19) United States
(12) Patent Application Publication
(10) Pub. No.: US 2009/0064605 A1
(43) Pub. Date: Mar. 12, 2009

(54) DOCK SEAL WITH PARTIALLY SLICED FOAM CORE

(76) Inventor: David J. Hoffman, Peosta, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/851,780

(22) Filed: Sep. 7, 2007

(51) Int. Cl. B65G 69/32

(52) U.S. Cl. 52/173.2; 52/309.4

(57) ABSTRACT

A dock seal, such as a header, side seal or draft pad mounted alongside a doorway of a loading dock, comprises a compressible foam core that includes a plurality of slits of insignificant thickness, wherein the slits can be strategically arranged and sized to adjust the seal's compression characteristics at different areas of the seal. In some cases, the slits extend only partially into the foam core so that the core remains intact as a unitary piece.

### FIELD OF DISCLOSURE

The subject disclosure generally pertains to vehicle loading docks and more specifically to a compressible seal for such a dock.

### BACKGROUND OF RELATED ART

When an exterior doorway of a building is used as a loading dock for vehicles, such as trucks and tractor/trailers, the perimeter of the doorway often includes a dock seal. Dock seals close off air gaps that would otherwise exist between the exterior face of the building and the back end of the trailer. Sealing the gaps allows cargo from the rear of the trailer to be loaded or unloaded while dockworkers and the cargo are protected from the weather.

Dock seals typically include two side seals running vertically along the lateral edges of the doorway, a top seal or header extending horizontally across the doorway's upper edge, and draft pads positioned near the lower ends of the side seals. Draft pads can help prevent air from blowing between the lip of a dock leveler and the side pads. A dock leveler is a well-known mechanical apparatus that provides a vertically adjustable bridge across which forklifts and other material handling equipment can travel between the building and the vehicle's cargo bed.

Although the actual construction of dock seals may vary, typical headers and side seals comprise a resiliently compressible foam core supported by a rigid backer, such as a wood plank or a formed metal plate. The foam core and backer are normally encased within a protective cover made of fabric or some other pliable material. Sealing is provided by backing the trailer up against the seal so that the seal compressively conforms to the rear shape of the trailer. The foam core provides the necessary compliance and resilience to repeatedly conform to the shape of various trailers; the outer cover protects the foam core from dirt, water and wear; and the backer provides solid structure for mounting the seal to the wall and for supporting the foam core so that the foam core does not twist and roll within the cover. Draft pads can be of similar construction but without the backer. Instead of a backer, a draft pad might simply be suspended from a side seal or an adjacent wall.

Besides being able to seal effectively, an important characteristic of dock seals is their ability to resist wear and withstand high compressive forces and prying action exerted by the vehicle. It is difficult, however, to provide a single uniform design that addresses all of these adverse conditions as different areas of the seal are subject to different types and levels of abuse. A header, for example, may be particularly subject to vertical prying action, side seals might experience concentrated compressive forces where a trailer's protruding hinges are forced deeply into the seal, and a draft pad might be more prone to getting caught and torn by the lower rear edges of the trailer.

Moreover, due to the trailer's wheel suspension, adding or removing cargo and/or driving a forklift on and off the cargo bed can cause the rear of the trailer to repeatedly rise and lower a few inches. Although such movement can create wear on all the seal members, most of the wear usually occurs where sharp edges of the vehicle engage the seal. Thus, certain areas of the seal often wear out before others.

Consequently, a need exists for a dock seal of simple construction where certain areas of the seal can be properly tuned to cope with various special conditions that occur at those particular areas.

### SUMMARY

In some embodiments, a dock seal comprises a compressible foam core that is sliced to modify the core's compression characteristics.

In some embodiments, the foam core of a dock seal includes a plurality of slits of varying depth.

In some embodiments, the foam core of a dock seal includes a first plurality of slits that traverse a second plurality of slits.

In some embodiments, the foam core of a dock seal includes an unevenly distributed plurality of slits.

In some embodiments, the foam core of a dock seal includes a plurality of slits that provide compression characteristics that vary along the length of the seal.

### BRIEF DESCRIPTION OF THE DRAWINGS

FIG. 1 is a perspective view of a vehicle backing to a loading dock that includes a novel dock seal.

FIG. 2 is a perspective view similar to FIG. 1 but showing the vehicle backed up against the dock seal.

FIG. 3 is a cross-sectional of one of the seal members shown in FIGS. 1.

FIG. 4 is a perspective view of a sliced foam core that can be used in the dock seal of FIG. 1.

FIG. 5 is a perspective view of another sliced foam core that can be used in the dock seal of FIG. 1.

FIG. 6 is a perspective view of another sliced foam core that can be used in the dock seal of FIG. 1.

FIG. 7 is a perspective view of another sliced foam core that can be used in the dock seal of FIG. 1.

FIG. 8 is a perspective view of another sliced foam core that can be used in the dock seal of FIG. 1.

FIG. 9 is a perspective view of another sliced foam core that can be used in the dock seal of FIG. 1.

### DETAILED DESCRIPTION

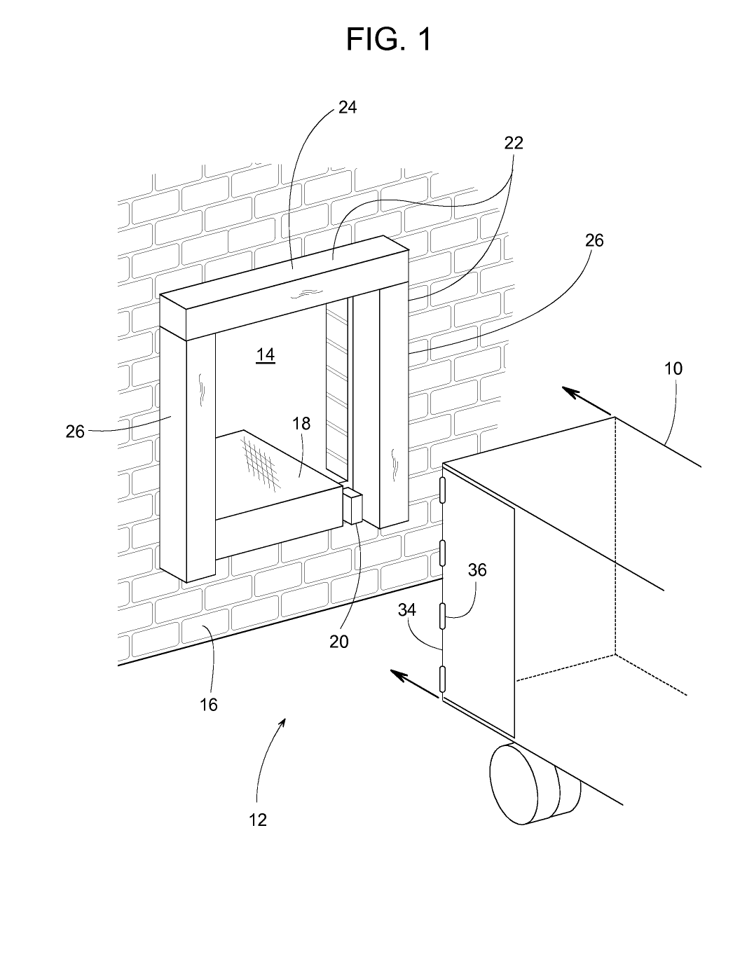

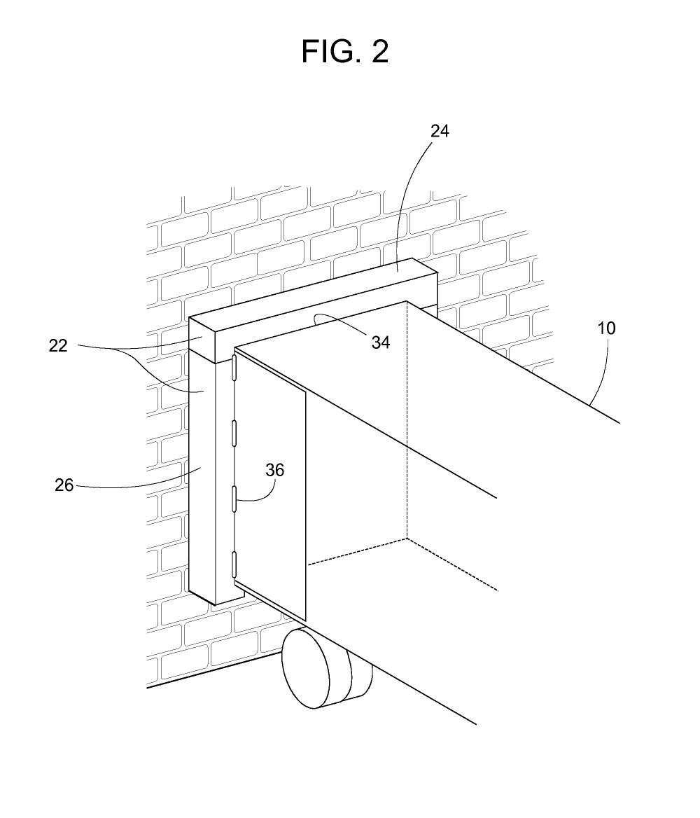

FIG. 1 shows a vehicle 10, such as a trailer of a truck, backing into a loading dock 12, and FIG. 2 shows vehicle 10 parked at its loading/unloading position. Loading dock 12 is basically a doorway 14 or an opening in a wall 16 of a building and may be associated with a dock leveler 18, bumpers 20, and other items that facilitate loading and unloading of the vehicle's cargo. One such item in particular is a compressible dock seal 22. Dock seal 22 may comprise a head seal 24, two lateral seals 26, and perhaps two draft pad seals. An example of a draft pad is disclosed in U.S. Pat. No. 6,014,844, which is specifically incorporated by reference herein.

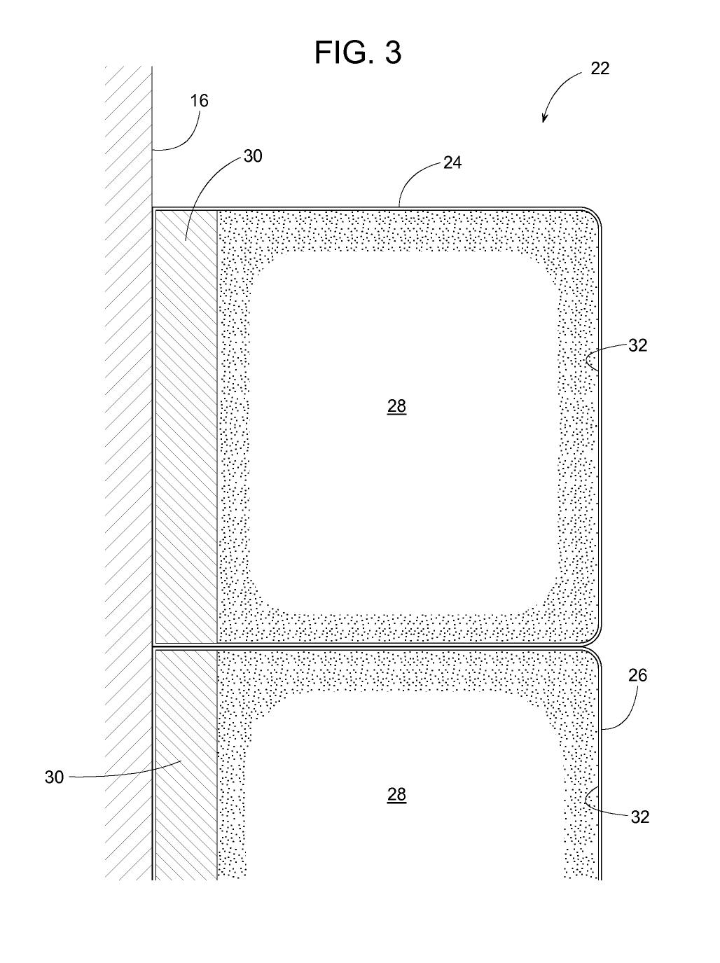

Referring to FIG. 3, the basic construction of seals 24 and 26 can comprise a resiliently compressible foam core 28 supported by a relatively rigid backer 30, such as a wood plank or a formed metal plate. Foam core 28 and backer 30 may be encased within a protective cover 32 made of fabric or some other pliable material. Sealing is accomplished by vehicle 10 backing up against seal 22 so that seal 22 compressively conforms to the shape of the vehicle's rear edge 34. Foam core 28 provides the necessary compliance and resilience to repeatedly conform to the shape of various vehicles; outer cover 32 protects foam core 28 from dirt, water and wear; and backer 30 provides solid structure for mounting seal 22 to wall 16 and for supporting foam core 28 so that the foam does not twist and roll within cover 32.

Typically, vehicle 10 presses its rear edges 34, protruding door hinges 36, trim, and other hardware tightly against dock seal 22. If the vehicle's rear edges 34 subsequently move up and down due to the vehicle's suspension responding to vehicle 10 being loaded and unloaded of cargo, or if the vehicle's trailer tilts due to the front end of the trailer being hitched or unhitched, then the trailer's rear edges 34, hinges 36, trim and other hardware might dig deeply into some areas of seal 22. To accommodate such loading, certain areas of foam core 28 are purposely designed or tuned to make seal 22 tolerant of such conditions.

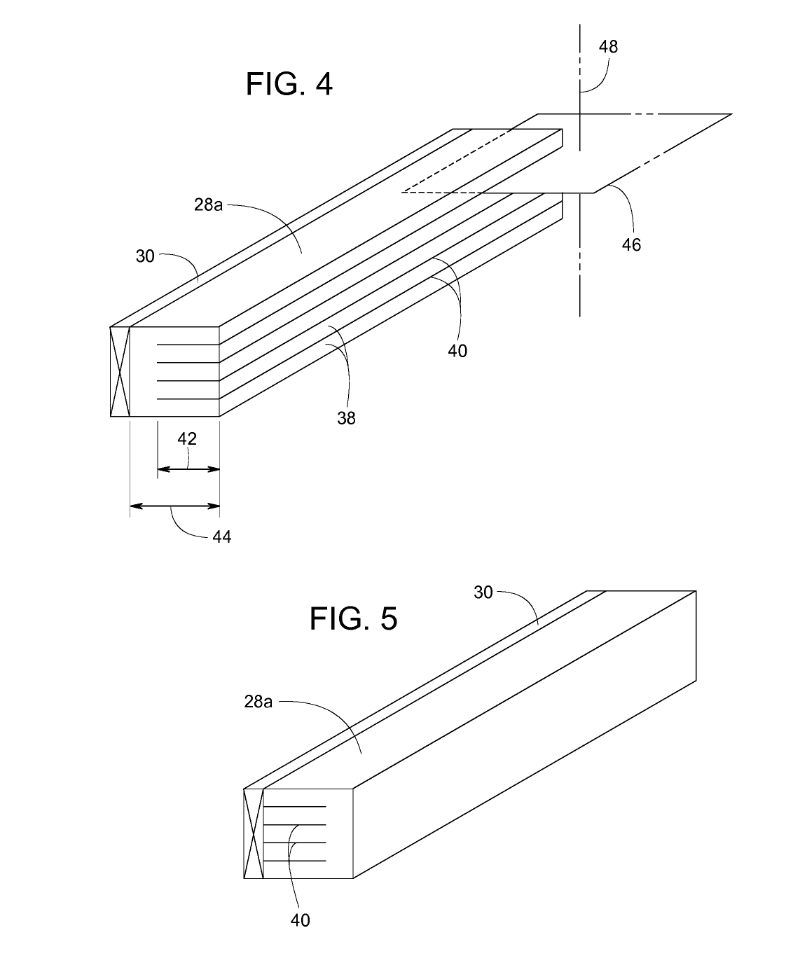

FIGS. 4-9, for instance, illustrate a slicing design concept that can be applied to the foam core of various dock seals. Each of the examples shows a sliced foam block that can serve as a core for a horizontally elongate header or a vertical side seal. It should be apparent to those of ordinary skill in the art that the basic slicing concept could also be readily applied to draft pads as well.

In the first example, shown in FIG. 4, foam core 28a is sliced to create a plurality of foam segments 38 disposed in juxtaposition. Slicing foam can be accomplished by various means including, but not limited to, a knife, saw, hot wire, high-pressure liquid stream (waterjet), etc. The slicing creates a plurality of slits 40, which preferably extend only to a limited, certain depth 42 that is less than an overall projection thickness 44 of foam core 28a so that core 28a remains intact as a unitary piece. It is well within the scope of this disclosure, however, to create an equivalent foam core that is comprised of an assembly of pieces that are glued or otherwise held together.

The plurality of slits 40 are of insignificant thickness or are sufficiently thin to allow contact between adjacent segments 38. The minimal or zero thickness of slits 40 allows core 28a to retain much of its compression characteristics that it would have had as a solid foam block, yet slits 40 provide core 28a with greater bending flexibility because segments 38 are capable of some relative movement (e.g. sliding relative to each other. Moreover, individual segments 38 can react to localized compression without the compression being distributed over a broader area; consequently, core 28a can more readily conform and thus seal against contours with abrupt surface changes such as a protruding hinge.

With slits 40 being in a generally horizontal orientation, as shown in FIG. 4, core 28a might be particularly suited for use in head seal 24 because core 28a could readily flex upward in response to vertical prying exerted by vehicle 10 by virtue of the provided relative movement between segments 38. Slits 40 do not necessarily have to be perfectly horizontal to provide such vertical flexibility. When core 28a is mounted to wall 16 as part of head seal 24, slits 40 would actually lie along imaginary planes 46 that traverse an imaginary vertical line 48 and wall 16. Nor do the various slits have to be of equal depth. Indeed, it may be desirable to have shallower slits 40 in certain areas—which would still provide for relative movement between segments 38, as well as more localized compression of individual segments, but on a more limited basis as compared to segments 38 adjacent deeper slits 40. This in effect allows the flexibility and/or compression characteristics of specific areas of the face of a dock seal to be programmed according to the needs of a given application. Flexibility is thus provided to the designer—in that he can identify areas of the seal where greater or lesser relative movement between segments or compressive response is desired—and easily design a seal having such area—specific characteristics without having to use different types of foam in the different areas—as is sometimes done conventionally.

Core 28a can be placed relative to backer 30 as shown in FIG. 4 or positioned as shown in FIG. 5. Core 28a can be bonded to backer 30 to help prevent core 28a from rolling and twisting underneath cover 32.

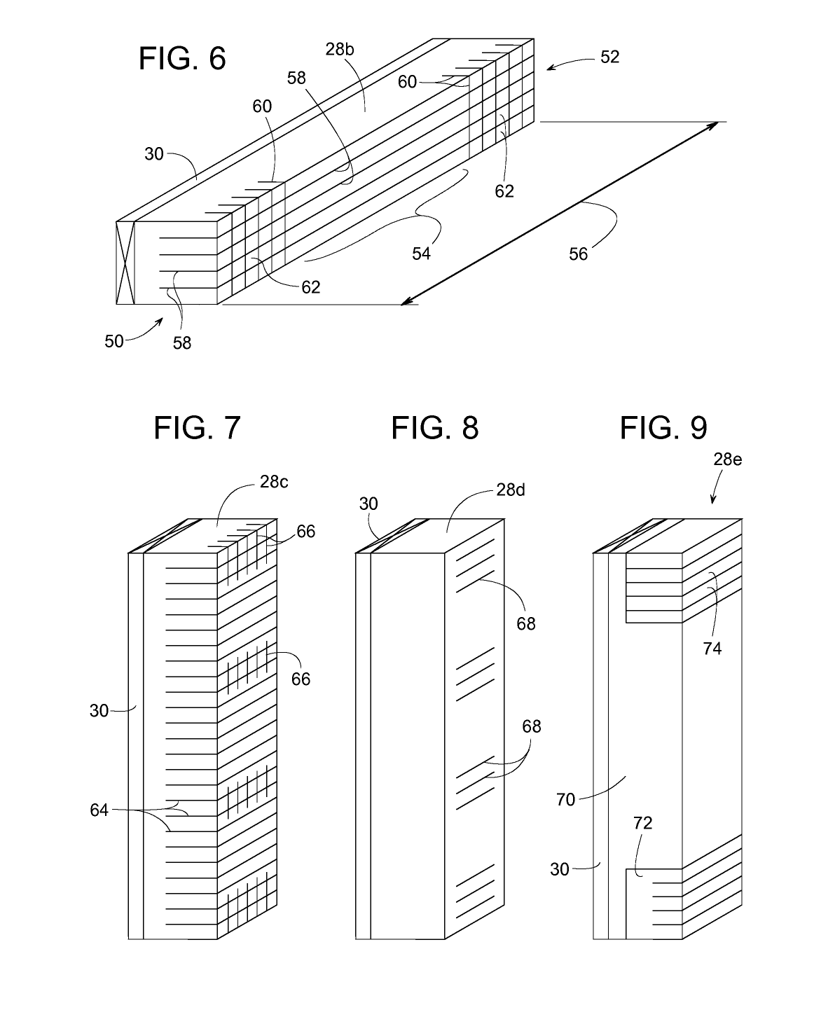

In some cases, it might be beneficial to have a foam core that is more flexible in some areas than others. As previously discussed, such an end might be achieved by having slits of varying depth. This could also be achieved by varying the distribution of the slits. FIG. 6, for instance, shows a foam core 28b that has a first end 50 and a second end 52 that are more flexible than a central region 54 due to a plurality of slits being unevenly distributed over the foam core's overall length 56. In this example, a first plurality of slits 58 increases the core's overall vertical flexibility, and a second plurality of slits 60 traversing slits 58 provides ends 50 and 52 with additional compliance. By cutting slits 58 and 60 to different depths, the resulting segments 62 might be less prone to becoming tangled among themselves.

In another embodiment, shown in FIG. 7, a foam core 28c includes a first plurality of slits 64 that can provide side seal 26 with vertical flexibility. Multiple sets of strategically placed additional slits 66 can provide extra compliance where hinges 36 are likely to engage the seal.

Although FIGS. 4-7 illustrate various embodiments, countless other embodiments are well within the scope of the disclosure. FIG. 8, for instance, provides an example of how a foam core 28d can include a plurality of slits 68 that are surrounded by a generally solid foam periphery. And FIG. 9 shows a foam core 28e that comprises an assembly of parts including a foam base 70, a sliced foam insert 72, and a stack of foam pads 74. These parts might be glued to each other or simply held together by cover 32.

It should be noted that the actual materials of core 28 and cover 32 could vary. In some cases, core 28 is an L24 open-cell polyurethane foam provided by Leggett & Platt of Carthage, Mo.; however, other foam materials and densities can be used. One example of cover 32 would be a 3022 MFRLPC DC7 material provided by the Seaman Corporation of Wooster, Ohio. Other examples of cover materials would include, but are not be limited to, hypalon, canvas duck, rubber impregnated fabric and coated nylon fabric.

Although the invention is described with respect to a preferred embodiment, modifications thereto will be apparent to those of ordinary skill in the art. The scope of the invention, therefore, is to be determined by reference to the following claims:

1. A dock seal mountable to a wall, the dock seal comprising:
a foam core comprising a plurality of segments disposed in juxtaposition, the plurality of segments define therewithin a plurality of slits that are sufficiently thin to allow two adjacent segments of the plurality of segments to touch each other, the foam core (including the plurality of segments) is a unitary piece; and
a flexible cover encasing at least some of the foam core.

2. The dock seal of claim 1, wherein the plurality of slits include a first plurality of slits and a second plurality of slits, the first plurality of slits are deeper than the second plurality of slits.

3. The dock seal of claim 1, wherein the plurality of slits include a first plurality of slits and a second plurality of slits, the first plurality of slits traverse the second plurality of slits.

4. The dock seal of claim 1, wherein at least two of the plurality of segments are capable of relative movement by virtue of a slit therebetween.

5. The dock seal of claim 1, wherein the foam core has an overall length, and the plurality of slits are unevenly distributed along the overall length.

6. The dock seal of claim 5, wherein the foam core includes a first end, a second end, and a central region therebetween, the overall length extends from the first end to the second end of the foam core, and the plurality of slits are more concentrated near the first end than at the central region.

7. The dock seal of claim 1, wherein the foam core is horizontally elongate when mounted to the wall, and the plurality of slits lie along a corresponding plurality of imaginary planes that traverse an imaginary vertical line.

8. The dock seal of claim 1, wherein a segment is capable of compressing independently of another segment by virtue of at least one slit adjacent thereto.

9. A dock seal mountable to a wall, the dock seal comprising:
a foam core comprising a plurality of segments disposed in juxtaposition, the plurality of segments define therewithin a plurality of slits that are sufficiently thin to allow two adjacent segments of the plurality of segments to touch each other, at least one slit of the plurality of slits lies along an imaginary plane that traverses the wall when the dock seal is mounted thereto; and
a flexible cover encasing at least some of the foam core.

10. The dock seal of claim 9, wherein the plurality of slits include a first plurality of slits and a second plurality of slits, the first plurality of slits are deeper than the second plurality of slits.

11. The dock seal of claim 9, wherein the plurality of slits include a first plurality of slits and a second plurality of slits, the first plurality of slits traverse the second plurality of slits.

12. The dock seal of claim 9, wherein the foam core has an overall length, and the plurality of slits are unevenly distributed along the overall length.

13. The dock seal of claim 12, wherein the foam core includes a first end, a second end, and a central region therebetween, the overall length extends from the first end to the second end of the foam core, and the plurality of slits are more concentrated near the first end than at the central region.

14. The dock seal of claim 9, wherein the foam core is horizontally elongate when mounted to the wall, and the plurality of slits lie along a corresponding plurality of imaginary planes that traverse an imaginary vertical line.

15. The dock seal of claim 9, wherein the foam core is vertically elongate when mounted to the wall.

16. A dock seal mountable to a wall, the dock seal comprising:
a foam core having an overall projection thickness as measured in a direction perpendicular to the wall when the dock seal is mounted thereto, the foam core comprises a plurality of segments disposed in juxtaposition, the plurality of segments define therewithin a plurality of slits that are sufficiently thin to allow two adjacent segments of the plurality of segments to touch each other, one slit of the plurality of slits lies along an imaginary plane that traverses the wall when the dock seal is mounted thereto, the one slit extends a certain depth into the foam core, wherein the certain depth is less than the overall projection thickness of the foam core; and
a flexible cover encasing at least some of the foam core.

17. The dock seal of claim 16, wherein the foam core (including the plurality of segments) comprises a unitary piece.

18. The dock seal of claim 17, wherein the plurality of slits include a first plurality of slits and a second plurality of slits, the first plurality of slits are deeper than the second plurality of slits.

19. The dock seal of claim 17, wherein the plurality of slits include a first plurality of slits and a second plurality of slits, the first plurality of slits traverse the second plurality of slits.

20. The dock seal of claim 17, wherein the foam core has an overall length, and the plurality of slits are unevenly distributed along the overall length.

21. The dock seal of claim 20, wherein the foam core includes a first end, a second end, and a central region therebetween, the overall length extends from the first end to the second end of the foam core, and the plurality of slits are more concentrated near the first end than at the central region.

22. The dock seal of claim 17, wherein the foam core is horizontally elongate when mounted to the wall, and the plurality of slits lie along a corresponding plurality of imaginary planes that traverse an imaginary vertical line.

23. The dock seal of claim 17, wherein the foam core is vertically elongate when mounted to the wall.
